(19) United States
(12) Patent Application Publication
(10) Pub. No.: US 2015/0223312 A1
(43) Pub. Date: Aug. 6, 2015

(54) X-Ray Imaging Apparatus

(71) Applicant: KONICA MINOLTA, INC., Tokyo (JP)

(72) Inventors: Ryouhei KIKUCHI, Tokyo (JP); Yoshihiko EGUCHI, Saitama (JP)

(73) Assignee: KONICA MINOLTA, INC., Tokyo (JP)

(21) Appl. No.: 14/616,082

(22) Filed: Feb. 6, 2015

(30) Foreign Application Priority Data
Feb. 6, 2014 (JP) 2014-020919

(51) Int. Cl. H05G 1/26; G01N 23/04

(52) U.S. Cl. CPC H05G 1/265; G01N 23/04

(57) ABSTRACT

An X-ray imaging apparatus includes: a plurality of detecting elements arranged two-dimensionally; a radiation sensor configured to change a voltage value to be output when radiation is emitted; a determining unit configured to determine whether radiation that has entered the radiation sensor is natural radiation based on a length of a period during which the voltage value output from the radiation sensor is outside a predetermined range set for the voltage value; and an emission start detecting unit configured to determine whether X-ray emission from an X-ray generator has been started based on a determination result indicating that the determining unit has determined that the radiation having entered the radiation sensor is not natural radiation.

The entire disclosure of Japanese Patent Application No. 2014-020919 filed on Feb. 6, 2014 including description, claims, drawings, and abstract are incorporated herein by reference in its entirety.

### BACKGROUND OF THE INVENTION

1. Field of the Invention

The present invention relates to X-ray imaging apparatuses, and more particularly, to an X-ray imaging apparatus that includes a radiation sensor.

2. Description of the Related Art

There are various kinds of X-ray imaging apparatuses that have been developed to generate charges at detecting elements in accordance with the dosage of emitted X-rays, and read out the generated charges as image data. X-ray imaging apparatuses of this type are known as FPDs (Flat Panel Detectors), and have been conventionally designed as special-purpose apparatuses (also referred to as anchored apparatuses) integrally formed with supporting bases or the like. In recent years, X-ray imaging apparatuses of a portable type (also called a cassette type or the like) that have detecting elements and the like housed in housings and can be carried around have been developed and already been put into practical use.

Such an X-ray imaging apparatus normally constructs an interface with an X-ray generator, and exchanges signals and the like with the X-ray generator. In the stage where the X-ray imaging apparatus is prepared for imaging, X-rays are emitted from the X-ray generator to the X-ray imaging apparatus via an object, and imaging is performed. In a case where the manufacturers of the X-ray imaging apparatus and the X-ray generator are different from each other, it is not always easy to construct an interface between the two apparatuses, or an interface cannot be constructed in some cases.

If an interface cannot be constructed (or is not constructed) between an X-ray imaging apparatus and an X-ray generator, the problems described below might occur, for example. In the X-ray imaging apparatus, a detecting element reset process is normally performed to remove charges remaining in the respective detecting elements prior to imaging. If no interface has not been constructed at this point, the X-ray imaging apparatus might continue the detecting element reset process without realizing that X-rays have been emitted from the X-ray generator. As a result, the charges generated in the detecting elements by the X-ray emission might be removed from the detecting elements by the reset process.

If such a situation occurs, the X-rays emitted from the X-ray generator are wasted, and the X-ray source of the X-ray generator is exhausted for nothing. Since the X-ray generator needs to emit X-rays again for imaging (or re-imaging), the patient as the object receives a higher exposure dose, and a strain is imposed on the patient.

To counter this problem, a radiation sensor is attached to an X-ray imaging apparatus in some cases, and an X-ray emission start is detected based on a value that is output from the radiation sensor. In this case, when detecting an X-ray emission start, the X-ray imaging apparatus suspends the detecting element reset process, and puts the switching elements of the respective detecting elements into an OFF state, so that the X-ray imaging apparatus is put into a charge accumulating state in which charges generated in the detecting elements by X-ray emission are accumulated in the detecting elements.

In a case where a radiation sensor is attached to an X-ray imaging apparatus as described above, however, the radiation sensor might sense a cosmic ray, and the X-ray imaging apparatus might wrongly detects an X-ray emission start based on the information about the cosmic ray. In view of this, JP 4881796 B1 suggests that an X-ray imaging apparatus is positioned so that the normal line of the detection surface of the radiation sensor attached to the X-ray imaging apparatus extends substantially in the horizontal direction prior to imaging, and the probability of entrance of a cosmic ray into the radiation sensor is reduced, for example.

In an X-ray imaging apparatus disclosed in JP 4763655 B1, sets of image data are compared with one another, and a check is made to determine whether there is an influence of an external radiation component different from X-rays emitted from an X-ray generator. If there is such an influence, the influence is removed.

In a case where the imaging method disclosed in JP 4881796 B1 is employed, the position of the X-ray imaging apparatus to be used for imaging is restricted. For example, unlike an X-ray imaging apparatus of a special-purpose type (an anchored type), an X-ray imaging apparatus of a portable type (a cassette type) has the advantage of being able to be inserted between the body of a patient and a bed and then perform imaging. In that case, however, the normal line of the detection surface of the radiation sensor extends substantially in the vertical direction. In a special-purpose X-ray imaging apparatus for so-called supine radiography that performs imaging by emitting X-rays from above onto a patient lying on a table, the normal line of the detection surface of the radiation sensor also extends substantially in the vertical direction. Therefore, in the case where the imaging method disclosed in JP 4881796 B1 is employed, the above described imaging cannot be performed with the X-ray imaging apparatus.

In a case where the method disclosed in JP 4763655 B1 is employed, a check can be made to determine whether there is an influence of an external radiation component, only after image data is read out. In a case where an X-ray imaging apparatus is designed to detect X-ray emission based on an output value from a radiation sensor as described above, immediacy is expected so as to immediately determine whether the cause of the output of the value from the radiation sensor is X-ray emission or external radiation, and instantly detect X-ray emission, instead of external radiation. By the method disclosed in JP 4763655 B1, however, a check can be made to determine whether radiation emitted to the X-ray imaging apparatus is X-rays or external radiation, only after image data is read out. Therefore, the timing of the check is too late.

In the description below, radiation other than X-rays emitted from an X-ray generator, such as the cosmic rays disclosed in JP 4881796 B1 and the external radiation disclosed in JP 4763655 B1, will be collectively referred to as natural radiation. Natural radiation includes not only radiation derived from nature as described above, but also radiation derived from radioactive materials such as artificial nuclear fuel scattering or leaking from a nuclear power plant or the like. Natural radiation also includes not only X-rays but also radiation having wavelengths that exceed the wavelength range of X-rays, such as y-rays. In this specification, the term “radiation” is used to refer to general radiation in cases where there is no need to distinguish natural radiation from X-rays emitted from an X-ray generator.

### SUMMARY OF THE INVENTION

The present invention has been made in view of the above problems, and an object thereof is to provide an X-ray imaging apparatus that has no restrictions on its position at a time of imaging, detects an X-ray emission start by distinguishing natural radiation and an X-ray emitted from an X-ray generator from each other in real time, and is capable of preventing false detection of an X-ray emission start due to natural radiation.

To achieve the abovementioned object, according to an aspect, an X-ray imaging apparatus reflecting one aspect of the present invention comprises: detecting elements that are two-dimensionally arranged; a radiation sensor that changes a voltage value to be output when radiation is emitted; a determining unit that determines whether radiation that has entered the radiation sensor is natural radiation based on the length of a period during which the voltage value output from the radiation sensor is outside a predetermined range set for the voltage value; and an emission start detecting unit that determines whether X-ray emission from an X-ray generator has been started based on a determination result indicating that the determining unit has determined that the radiation having entered the radiation sensor is not natural radiation.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a cross-sectional view of an X-ray imaging apparatus;

FIG. 2 is a top view of the X-ray imaging apparatus shown in FIG. 1;

FIG. 3 is a diagram showing the temporal transition of an analog voltage value (the lower section) of a radiation sensor according to an embodiment, and an example of the pulse signal (the upper section) that is output in accordance with the analog voltage value;

FIG. 4 is a plan view showing the structure of the substrate of the X-ray imaging apparatus;

FIG. 5 is a block diagram showing an equivalent circuit of the X-ray imaging apparatus;

FIG. 6A is a diagram showing the temporal transition of an analog voltage value (the lower section) of the radiation sensor and an example of the pulse signal (the upper section) that is output in accordance with the analog voltage value in a case where a pulse signal P is output only once in a predetermined time since X-rays enter the radiation sensor;

FIG. 6B is a diagram showing the temporal transition of an analog voltage value (the lower section) of the radiation sensor and an example of the pulse signal (the upper section) that is output in accordance with the analog voltage value in a case where a pulse signal P is output twice in the predetermined time since X-rays enter the radiation sensor;

FIG. 7A is a diagram showing the temporal transition of an analog voltage value (the lower section) of the radiation sensor and an example of the pulse signal (the upper section) that is output in accordance with the analog voltage value in a case where a pulse signal P is output many times in the predetermined time since natural radiation enters the radiation sensor; and

FIG. 7B is a diagram showing the temporal transition of an analog voltage value (the lower section) of the radiation sensor and an example of the pulse signal (the upper section) that is output in accordance with the analog voltage value in a case where a pulse signal P is output twice in the predetermined time since natural radiation enters the radiation sensor.

### DESCRIPTION OF THE PREFERRED EMBODIMENTS

Hereinafter, an embodiment of an X-ray imaging apparatus of the present invention will be described with reference to the drawings. However, the scope of the invention is not limited to the illustrated examples.

In the description below, an X-ray imaging apparatus of a so-called indirect type that includes a scintillator and the like, and obtains electric signals by converting emitted X-rays into electromagnetic waves of another wavelength such as visible light will be described as an X-ray imaging apparatus of the present invention. However, the present invention can also be applied to an X-ray imaging apparatus of a so-called direct type that detects X-rays with detecting elements without a scintillator or the like.

Although the X-ray imaging apparatus described below is of a so-called portable type, the present invention can also be applied to an X-ray imaging apparatus of a special-purpose type that is integrally formed with a supporting base or the like.

### X-Ray Imaging Apparatus

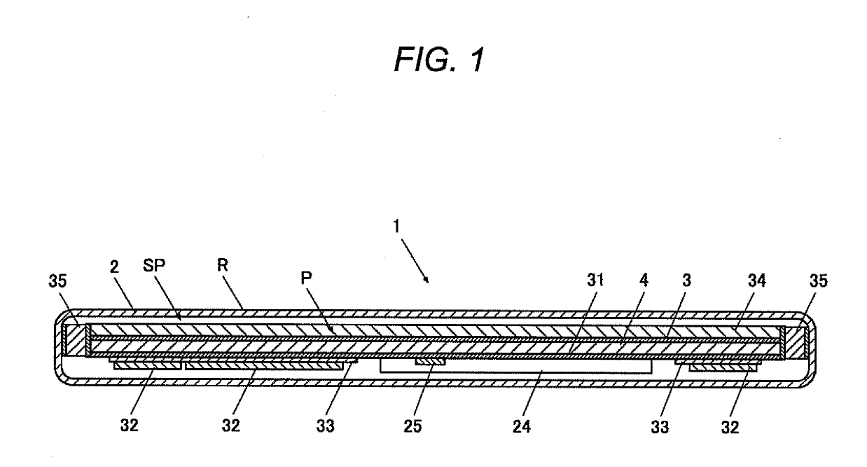

First, the structure and the like of an X-ray imaging apparatus used in an X-ray imaging system according to this embodiment are described. FIG. 1 is a cross-sectional view of the X-ray imaging apparatus according to this embodiment. The description below is based on the vertical and horizontal directions in a situation where the X-ray imaging apparatus 1 is placed on a horizontal surface so that the X-ray incidence surface R, which is the surface on the side of X-ray incidence, faces upward as shown in FIG. 1. Relative sizes, relative lengths, and the like of the respective components and the like of the X-ray imaging apparatus 1 in the respective drawings do not necessarily reflect the structure of an X-ray imaging apparatus in reality.

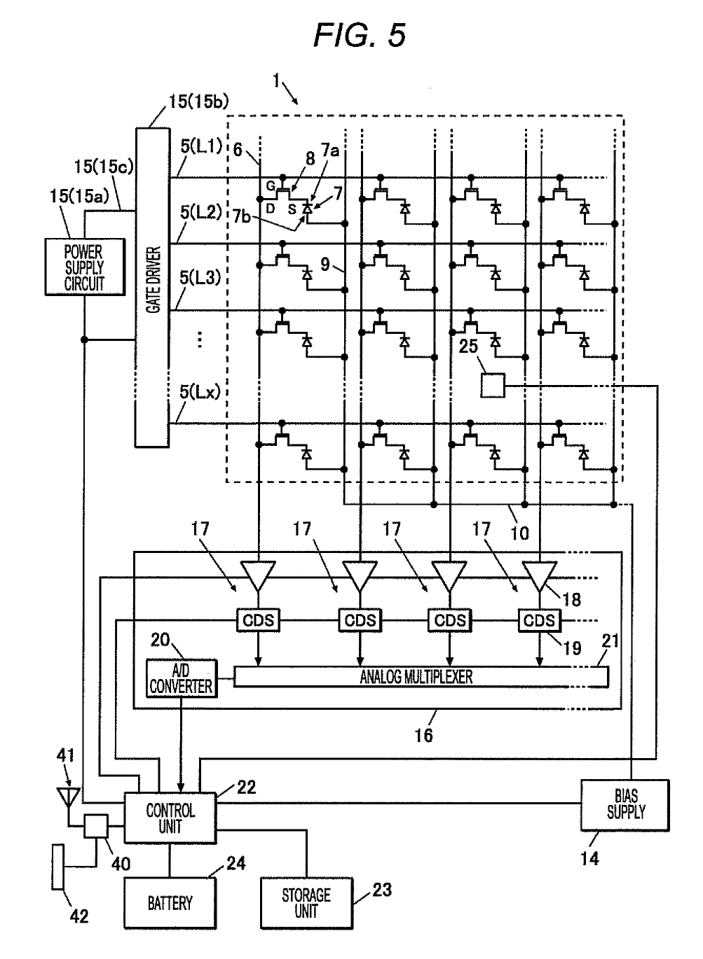

As shown in FIG. 1, the X-ray imaging apparatus 1 is formed by placing a sensor panel SP formed with a scintillator 3, a sensor substrate 4, and the like in a housing 2 formed with a carbon panel or the like having the X-ray incidence surface R. A buffer material 35 is provided between the sensor panel SP and the inner sides of the side surfaces of the housing 2. Although not shown in FIG. 1, an antenna 41 (see FIG. 5, which will be described later) that is a wireless communication unit of transmitting image data D and the like to an image processing apparatus (not shown) in a wireless manner is placed in the housing 2 in this embodiment. Although not shown in FIG. 1, either, the X-ray imaging apparatus 1 includes a connector 42 (see FIG. 5, which will be described later) on a side surface side of the housing 2 in this embodiment, so that signals, data, and the like can be transmitted to a console, an image processing apparatus, or the like (not shown) via the connector 42 in a wired manner. As shown in FIG. 5, which will be described later, a communication unit 40 having the antenna 41, the connector 42, and the like connected thereto functions as a communication unit for the X-ray imaging apparatus 1.

As shown in FIG. 1, a base 31 is placed in the housing 2, and the sensor substrate 4 is placed on the side of the X-ray incidence surface R or the upper surface side of the base 31 via a lead thin plate (not shown). On the upper surface side of the sensor substrate 4, the scintillator 3 that converts emitted X-rays into light such as visible light is placed on a scintillator substrate 34, and the scintillator 3 is placed so as to face the sensor substrate 4. A PCB substrate 33 having electronic components 32 and the like, a battery 24 placed thereon, and the like are attached to the lower surface of the base 31.

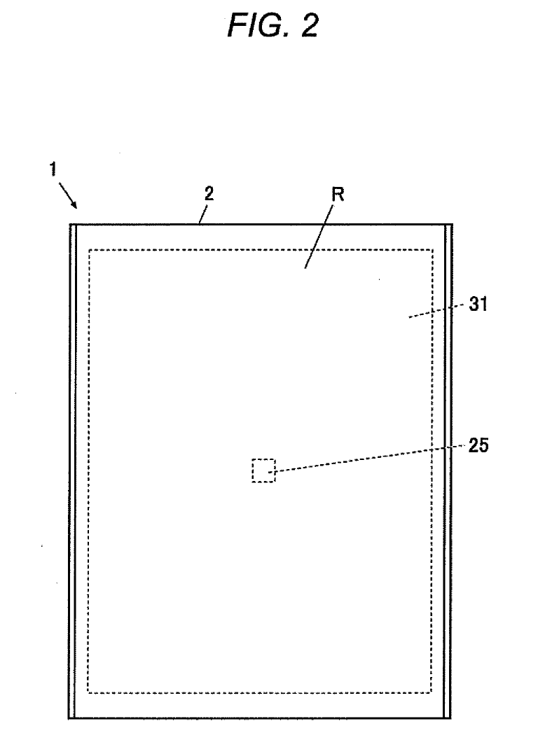

A radiation sensor 25 is also attached to the lower surface of the base 31. In this embodiment, the radiation sensor 25 is sensitive not only to X-rays but also to general radiation. The radiation sensor 25 is placed in the center position on the lower surface of the base 31 as shown in FIG. 2, but the attachment position may not be the center position. FIG. 2 is a diagram of the X-ray imaging apparatus 1, seen from the side of the X-ray incidence surface R or from above. Although the radiation sensor 25 is attached directly to the base 31 in FIG. 1, the radiation sensor 25 may be attached to the base 31 via the PCB substrate 33 or the like, or may be attached to an inner side of the housing 2. The radiation sensor 25 may be placed in any appropriate position in the X-ray imaging apparatus 1 in any appropriate manner.

In the description below, the single radiation sensor 25 is provided as described above. However, more than one radiation sensor 25 may be provided. In that case, the radiation sensors 25 can be arranged at respective positions such as the edges or the corners of the X-ray incidence surface R of the X-ray imaging apparatus 1.

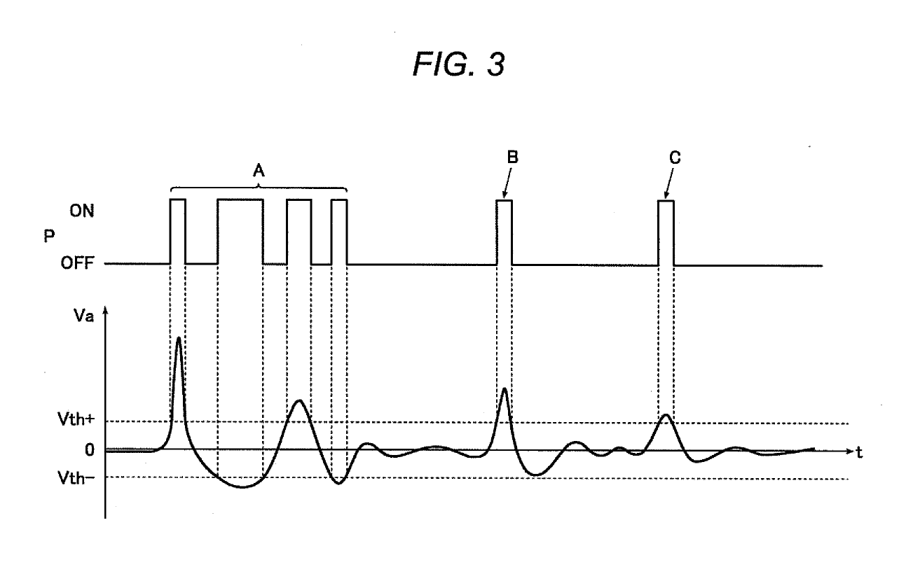

In this embodiment, the radiation sensor 25 is a radiation sensor that detects not only X-rays emitted from an X-ray generator but also natural radiation described above. When X-rays are emitted or natural radiation is detected, the radiation sensor changes the voltage value to be output. Specifically, when X-rays or the like are emitted onto a photodiode or the like (not shown), an ionization effect occurs, and a current flows. The radiation sensor 25 converts the current into an analog voltage value. In the radiation sensor 25 of this embodiment, a positive threshold value Vth+ and a negative threshold value Vth− are set for the analog voltage value Va as shown in FIG. 3. The radiation sensor 25 is designed to output a pulse signal P when the analog voltage value Va changes to a voltage value outside a range that has the positive threshold value Vth+ as the upper limit and the negative threshold value Vth− as the lower limit (or a voltage value that is higher than the positive threshold value Vth+ or is lower than the negative threshold value Vth−).

Symbols A, B, and C in FIG. 3 will be described later. In the above case, the positive and negative threshold values Vth+ and Vth− can be set so that the absolute values of the two threshold values become the same, or can be set so that the absolute values of the two threshold values become different from each other. As the radiation sensor 25, a radiation sensor that outputs the analog voltage value Va as it is converted from a current value can be used. Furthermore, the X-ray generator is an X-ray generator that includes an X-ray source such as a Coolidge X□ray source or a rotating anode X-ray source, and is widely used in medical practice. The present invention is not limited to cases where a specific X-ray generator is used.

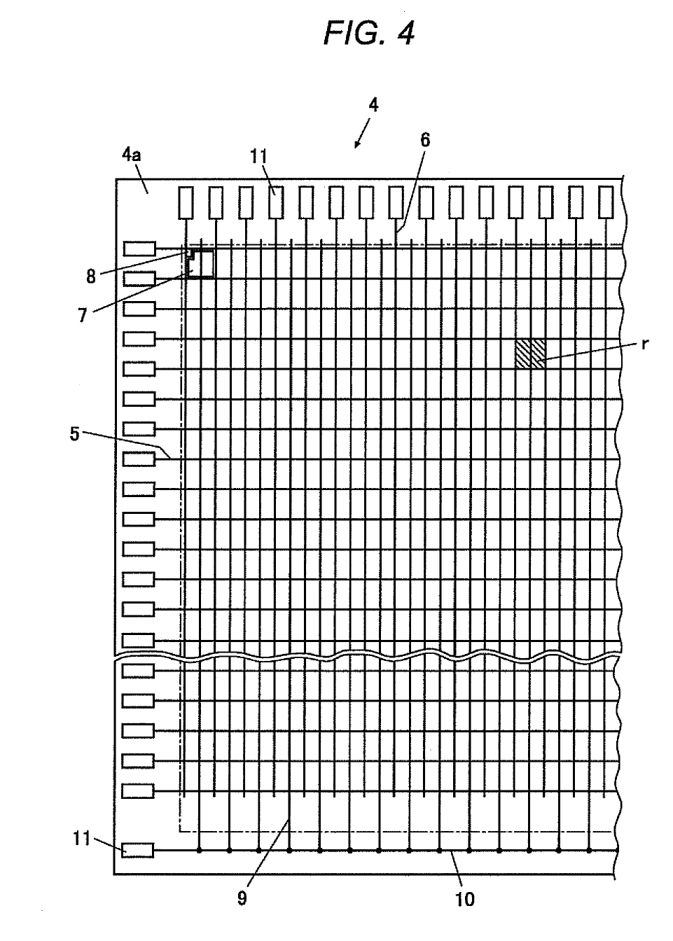

In this embodiment, the sensor substrate 4 is formed with a glass substrate, and scanning lines 5 and signal lines 6 are arranged so as to intersect each other on the upper surface (or the surface facing the scintillator 3) 4a of the sensor substrate 4 as shown in FIG. 4. Further, a detecting element 7 is provided in each of the small regions r defined by the scanning lines 5 and the signal lines 6 on the surface 4a of the sensor substrate 4. In this embodiment, the detecting elements 7 are photodiodes, but it is possible to use phototransistors or the like, for example.

The circuit configuration of the X-ray imaging apparatus 1 is now described. FIG. 5 is a block diagram of the X-ray imaging apparatus 1 according to this embodiment. The source electrode 8s (see “S” in FIG. 5) of a. thin-film transistor (hereinafter referred to as “TFT”) 8 that is a switching element is connected to a first electrode 7a of each detecting element 7. The drain electrode 8d and the gate electrode 8g (see “D” and “G” in FIG. 5) of the TFT 8 are connected to the corresponding signal line 6 and the corresponding scanning line 5, respectively. When an on-state voltage is applied to the gate electrode 8g from a scanning drive unit 15 described later via the scanning line 5, the TFT 8 is put into an ON state, and releases the charges accumulated in the detecting element 7 to the signal line 6 via the source electrode 8s and the drain electrode 8d. When an off-state voltage is applied to the gate electrode 8g via the scanning line 5, the TFT 8 is put into an OFF state, and stops the charge release from the detecting element 7 to the signal line 6, to accumulate charges in the detecting element 7.

In this embodiment, one bias line 9 is connected to the second electrodes 7b of the respective detecting elements 7 of each one row on the sensor substrate 4, and the respective bias lines 9 are connected by a connecting wire 10 at an edge portion of the sensor substrate 4, as shown in FIGS. 4 and 5. The connecting wire 10 is connected to a bias supply 14 (see FIG. 5) via an input/output terminal 11 (also called a pad; see FIG. 4), and a reverse bias voltage is applied to the second electrode 7b of each detecting element 7 from the bias supply 14 via the connecting wire 10 and each corresponding bias line 9.

Meanwhile, each scanning line 5 is connected to a gate driver 15b of the scanning drive unit 15 via each corresponding input/output terminal 11. In the scanning drive unit 15, the on-state voltage and the off-state voltage are supplied from a power supply circuit 15a to the gate driver 15b via a wire 15c, and the voltage to be applied to respective lines L1 to Lx of the scanning lines 5 is switched between the on-state voltage and the off-state voltage by the gate driver 15b.

The respective signal lines 6 are connected to respective readout circuits 17 included in a readout IC 16 via the respective input/output terminals 11. In this embodiment, each readout circuit 17 is formed mainly with an amplifier circuit 18, a correlated double sampling circuit 19, and the like. Although not shown in the drawing, each amplifier circuit 18 is formed with a charge amplifier circuit that is formed by connecting an operational amplifier, a capacitor, and the like in parallel, and the voltage value corresponding to the amount of charges accumulated in the capacitor is output from the output side of the operational amplifier to the correlated double sampling circuit 19 (see “CDS” in FIG. 5) in this embodiment. As shown in FIG. 5, an analog multiplexer 21 and an A/D converter 20 are further provided in the readout IC 16.

When image data D is read from the respective detecting elements 7, the on-state voltage is applied to a scanning line 5 from the gate driver 15b of the scanning drive unit 15, to put the respective TFTs 8 into an ON state. Charges are then released from the respective detecting elements 7 to the signal lines 6 via the respective TFTs 8, and are then accumulated in the capacitors of the amplifier circuits 18 of the readout circuits 17. At the amplifier circuit 18 of each readout circuit 17, the voltage value corresponding to the amount of charges accumulated in the capacitor is then output from the operational amplifier to the correlated double sampling circuit 19, as described above.

Each correlated double sampling circuit 19 outputs the increase in the value of the output from each corresponding amplifier circuit 18 as the analog image data D to the downstream side. The increase is the difference in the output value between before and after the charge flow from the corresponding detecting element 7 into the amplifier circuit 18 The respective pieces of the output image data D are sequentially transmitted to the A/D converter 20 via the analog multiplexer 21, are sequentially converted into digital image data D by the A/D converter 20, and are sequentially output and stored into a storage unit 23. In this manner, a process of reading out the image data D is performed.

A control unit 22 is formed with a computer in which a CPU (Central Processing Unit), a ROM (Read Only. Memory), a RAM (Random Access Memory), an input/output interface, and the like are connected by a bus, an FPGA (Field Programmable Gate Array), or the like (not shown). The control unit 22 may be formed with a special-purpose control circuit. The control unit 22 controls operations and the like of the respective functional units of the X-ray imaging apparatus 1, controlling the scanning drive unit 15 and the readout circuits 17 to perform the process of reading out the image data D as described above, for example.

As shown in FIG. 5, the storage unit 23 formed with an SRAM (Static RAM), an SDRAM (Synchronous DRAM), or the like is connected to the control unit 22. In this embodiment, the above described communication unit 40 having the antenna 41, the connector 42, and the like connected thereto is connected to the control unit 22, and the battery 24 that supplies necessary power to respective functional units such as the scanning drive unit 15, the readout circuits 17, the storage unit 23, and the bias supply 14 is further connected to the control unit 22.

In this embodiment, the control unit 22 also functions as the later described determining unit and the emission start detecting unit of the X-ray imaging apparatus 1. However, the control unit 22 may be provided as a different unit from the determining unit and the emission start detecting unit. In the description below, when the control unit 22 functions as the determining unit or the emission start detecting unit, the control unit 22 will be referred to as the determining unit 22 or the emission start detecting unit 22. Also, as shown in FIG. 5, the above described radiation sensor 25 is electrically connected to the determining unit 22 (the control unit 22), and a signal that is output from the radiation sensor 25 is input to the determining unit 22.

### Structure and the Like Characteristic of the Present Invention

Next, the structure and the like characteristic of the present invention for preventing false detection of an X-ray emission start when natural radiation is detected are described. The effects of the X-ray imaging apparatus 1 according to this embodiment are also described.

In this embodiment, the emission start detecting unit 22 basically determines whether X-rays are emitted from the X-ray generator (not shown) based on the pulse signal P that is output from the radiation sensor 25 as described above. However, the radiation sensor 25 outputs the pulse signal P not only when detecting X-rays emitted from the X-ray generator but also when detecting natural radiation. Therefore, when natural radiation is emitted, an X-ray emission start might be falsely detected based only on the pulse signal P output from the radiation sensor 25.

Also, in a case where a radiation sensor that outputs the analog voltage value Va as it is converted from a current value as described above is used as the radiation sensor 25, the emission start detecting unit 22 is designed to determine whether X-rays are emitted from the X-ray generator based on the analog voltage value Va that is output from the radiation sensor 25. At this point, the variation in the analog voltage value Va to be output from the radiation sensor 25 becomes larger not only when X-rays emitted from the X-ray generator are detected but also when natural radiation is detected. Therefore, based only on the analog voltage value Va output from the radiation sensor 25, an X-ray emission start might be falsely detected when natural radiation is emitted.

In view of the above, in the X-ray imaging apparatus 1 according to the present invention, the determining unit 22 first determines whether the radiation that has entered the radiation sensor 25 is natural radiation based on the pulse width of the pulse signal P output from the radiation sensor 25 (or the duration of time during which the pulse signal P is ON) and the length of the period during which the voltage value Va is outside the predetermined range. The emission start detecting unit 22 is designed to determine whether X-ray emission from the X-ray generator has been started based on a determination result indicating that the determining unit 22 has determined that the radiation having entered the radiation sensor 25 is not natural radiation.

In this embodiment, the radiation sensor 25 is designed to output the pulse signal P when the analog voltage value Va changes to a voltage value outside the range that has the positive threshold value Vth+ as the upper limit and the negative threshold value Vth− as the lower limit, as described above. Accordingly, the above described pulse width of the pulse signal P becomes equal to the length of the period during which the voltage value Va is outside the predetermined range (or the range having the positive threshold value Vth+ as the upper limit and the negative threshold value Vth− as the lower limit).

### Phenomenon That Occurs When Radiation is Emitted Onto the Radiation Sensor

Before the above structure and the like in this embodiment are described in detail, a phenomenon that occurs when radiation including X-rays or natural radiation is emitted onto the radiation sensor 25 is described below.

When X-rays are emitted from the X-ray generator onto the X-ray imaging apparatus 1 at a certain dose rate (or a dose per unit time), for example, the on-state signal (see “ON” of the pulse signal P in FIG. 3) is not constantly output from the radiation sensor 25 provided in the X-ray imaging apparatus 1, but a signal in the form of a pulse, or the pulse signal P, is output. This is because current flows in the photodiode and the like of the radiation sensor 25 only after phones forming X-rays enter the radiation sensor 25. If the X-ray emission from the X-ray generator continues, the photons forming X-rays constantly enter the radiation sensor 25. Therefore, as long as the X-ray emission continues, the pulse signal P continues to be intermittently output from the radiation sensor 25.

When natural radiation enters the radiation sensor 25, the pulse signal P is also output from the radiation sensor 25. However, natural radiation normally enters the radiation sensor 25 at once, unlike X-rays emitted from the X-ray generator.

When X-rays emitted from the X-ray generator enter the radiation sensor 25, for example, the analog voltage value Va instantly increases and exceeds the positive threshold value Vth+ at the time of the entrance of the X-rays as indicated by the waveform of the analog voltage value Va corresponding to the pulse signal P denoted by B and C in FIG. 3, for example, and the pulse signal P is output. However, even if the voltage value Va then varies in a wave-like manner, the voltage value Va does not easily become lower than the negative threshold value Vth− or become again higher than the positive threshold value Vth+. Therefore, when X-rays enter the radiation sensor 25 once, the pulse signal P is output only once in many cases. Although not shown in the drawings, in a case where X-rays that have entered the radiation sensor 25 are strong, the voltage value Va becomes higher than the positive threshold value Vth+ at the time of the entrance of the X-rays, and the pulse signal P is output once. Immediately after that, the voltage value Va becomes lower than the negative threshold value Vth−, and the pulse signal P is once again output in some cases. In this manner, while X-rays enter the radiation sensor 25 once, the pulse signal P might be output twice.

On the other hand, natural radiation normally has a greater energy than X-rays emitted from an X-ray generator. Therefore, when natural radiation enters the radiation sensor 25, the waveform of the voltage value Va greatly varies, like the analog voltage value Va corresponding to the pulse signal P denoted by A in FIG. 3, for example. Therefore, a phenomenon described below occurs. At the time of entrance of natural radiation, the voltage value Va becomes higher than the positive threshold value Vth+, and the pulse signal P is output. After that, the voltage value Va becomes lower than the negative threshold value Vth−, and the pulse signal P is again output. The voltage value Va again becomes higher than the positive threshold value Vth+, and the pulse signal P is output. In view of this, when natural radiation enters the radiation sensor 25 once, the pulse signal P is output more than once in many cases.

Also, natural radiation has a greater energy than X-rays emitted from the X-ray generator as described above. Therefore, when natural radiation enters the radiation sensor 25, the analog voltage value Va changes to the positive side or the negative side by a greater amount than in a case where X-rays emitted from the X-ray generator enter the radiation sensor 25. As a result, the period during which the analog voltage value Va is higher than the positive threshold value Vth+ (or the pulse width of the corresponding pulse signal F) and the period during which the analog voltage value Va is lower than the negative threshold value Vth− (or the pulse width of the corresponding pulse signal P) tend to become longer than in a case where X-rays emitted from the X-ray generator enter the radiation sensor 25.

From the studies made by the inventors, it has become apparent that, when natural radiation enters the radiation sensor 25 once, the number of times the pulse signal P is output from the radiation sensor 25 becomes larger, or the pulse width of the pulse signal P to be output becomes greater than in a case where X-rays emitted from the X-ray generator enter the radiation sensor 25 once. It is expected that, with this phenomenon being taken advantage of, a check can be made to determine whether radiation having entered the radiation sensor 25 is natural radiation or X-rays emitted from the X-ray generator.

In the present invention, so as to determine whether radiation having entered the radiation sensor 25 is natural radiation or X-rays by taking advantage of the above described phenomenon, the determining unit 22 (or the control unit 22 in this embodiment) determines whether radiation having entered the radiation sensor 25 is natural radiation based on the length of the period during which the analog voltage value Va at the radiation sensor 25 is outside the predetermined range (or the range that has the positive threshold value Vth+ as the upper limit and the negative threshold value Vth− as the lower limit in the above described example).

In this embodiment, the radiation sensor 25 is designed to output the pulse signal P when the analog voltage value Va changes to a voltage value outside the predetermined range as described above. Since the pulse width of the pulse signal P and the length of the period during which the analog voltage value Va is outside the predetermined range are equal to each other as described above, the length of the period will be explained as the pulse width of the pulse signal P in the description below. In a case where the radiation sensor 25 is designed to output the analog voltage value Va, the positive and negative threshold values Vth+ and Vth− may be set in the determining unit 22 in advance, and the determining unit 22 may be designed to measure the length of the period during which the analog voltage value Va output from the radiation sensor 25 is higher than the positive threshold value Vth+, and the length of the period during which the analog voltage value Va is lower than the negative threshold value Vth−.

### Specific Methods of Detecting Natural Radiation Based on Pulse Width

Specific methods for the determining unit 22 to determine whether radiation having entered the radiation sensor 25 is natural radiation based on the pulse width of the pulse signal P output from the radiation sensor 25 are now described through several example structures.

### Example Structure 1

For example, the determining unit 22 can be designed to determine that radiation having entered the radiation sensor 25 is natural radiation when the total value ΣWp of the pulse widths Wp of the respective pulse signals P that are output in a predetermined time (such as 100 μs or 200 μs) since the analog voltage value Va from the radiation sensor 25 exceeds the positive threshold value Vth+ and the pulse signal P starts to be output is equal to or greater than a threshold value Σth, the respective pulse signals P including the first pulse signal P.

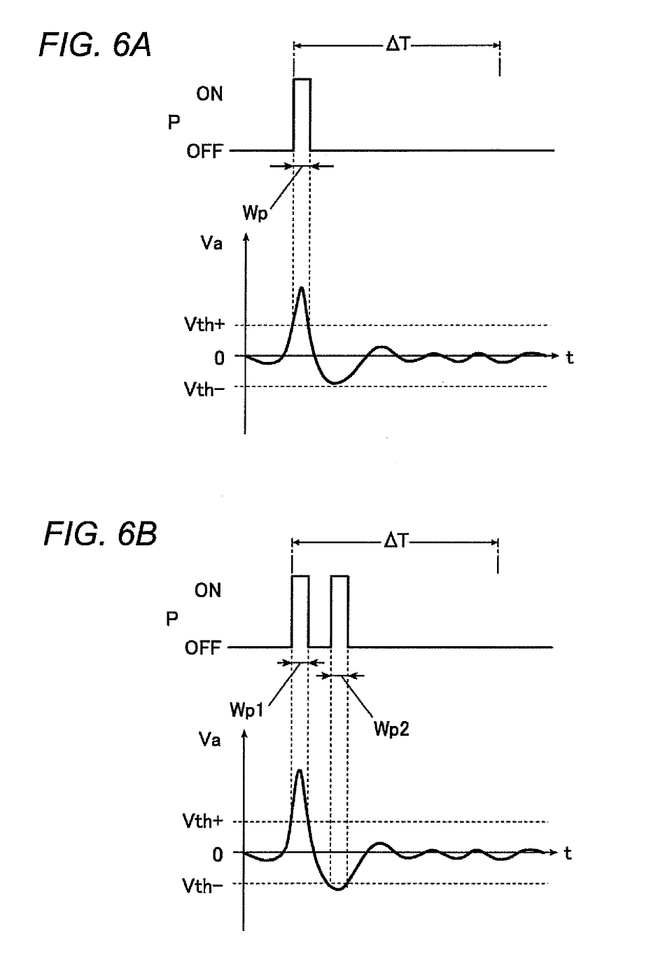

If the radiation having entered the radiation sensor 25 is X-rays emitted from the X-ray generator, the pulse signal P is output only once in the above described predetermined time AT as shown in FIG. 6A, for example, and the pulse width Wp is not so long (see “B” and “C” in FIG. 3). Accordingly, the total value ΣWp of the pulse widths Wp of the pulse signals P output in the predetermined time ΔT since the start of output of the pulse signals P is equal to the pulse width Wp of the first pulse signal P, and is smaller than the threshold value Σth. In this case, the determining unit 22 determines that the radiation having entered the radiation sensor 25 is not natural radiation (or is X-rays emitted from the X-ray generator). The threshold value Σth is set at an appropriate duration such as 50 μs.

In a case where the analog voltage value Va from the radiation sensor 25 becomes lower than the negative threshold value Vth− after exceeding the positive threshold value Vth+, and two pulse signals P1 and P2 are output in the above described predetermined time ΔT, as shown in FIG. 6B, the determining unit 22 also determines that the radiation having entered the radiation sensor 25 is not natural radiation, if the total value ΣWp (=Wp1+Wp2) of the pulse widths Wp1 and Wp2 of the pulse signals P1 and P2 output in the predetermined time ΔT is smaller than the threshold value Σth.

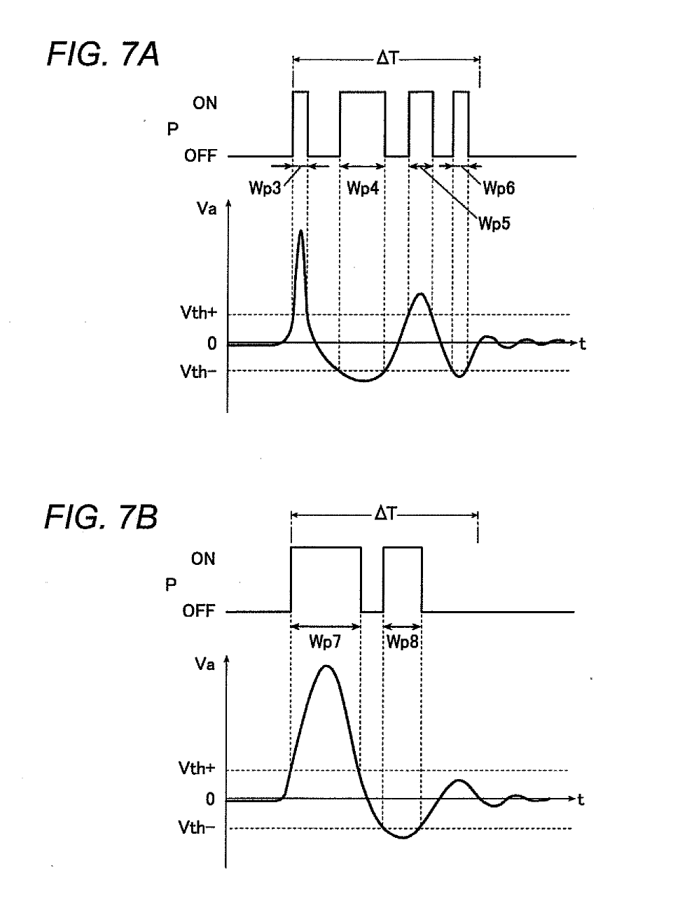

On the other hand, in a case where the total value ΣWp (Wp3+Wp4+Wp5+Wp6 in the case shown in FIG. 7A) of the pulse widths Wp of the respective pulse signals P that are output in the predetermined time ΔT since the analog voltage value Va from the radiation sensor 25 greatly changes to the positive side and the negative side and the pulse signal P starts to be output is equal to or greater than the threshold value Σth, as shown in FIG. 7A, the determining unit 22 determines that the radiation having entered the radiation sensor 25 is natural radiation.

In a case where the total value ΣWp (Wp7+WpB in the case shown in FIG. 7B) of the pulse widths Wp of the respective pulse signals P that are output in the predetermined time ΔT is equal to or greater than the threshold value Σth even though the pulse signal P is output twice in the predetermined time ΔT since the pulse signal P starts to be output from the radiation sensor 25, as shown in FIG. 7B, the determining unit 22 determines that the radiation having entered the radiation sensor 25 is natural radiation. Furthermore, although not shown in the drawings, in a case where the pulse width Wp (or the total value ΣWp) of the pulse signal P output in the predetermined time ΔT is equal to or greater than the threshold value Σth even if the pulse signal P is output only once in the predetermined time ΔT since the pulse signal P starts to be output from the radiation sensor 25 (or in a case where the pulse width Wp of the pulse signal P that is output only once is equal to or greater than the threshold value Σth), the determining unit 22 also determines that the radiation having entered the radiation sensor 25 is natural radiation.

In other words, in this example structure 1, the above described threshold value Σth at the determining unit 22 is set so that natural radiation is not detected (or non-natural radiation is detected) when the threshold value Σth is a value shown in FIG. 6A or 63, and natural radiation is detected when the threshold value Σth is a value shown in FIG. 7A or 73.

### Example Structure 2

As can be seen from a comparison between FIG. 6B and FIG. 7A or 7B, the total value of the pulse widths Wp of at least two pulse signals P including the first output pulse signal P is greater in a case where the radiation having entered the radiation sensor 25 is X-rays emitted from the X-ray generator (see FIG. 6B) than in a case where the radiation having entered the radiation sensor 25 is natural radiation (see FIG. 7A or 7B). This is because, when natural radiation enters the radiation sensor 25 once, the pulse width of the pulse signal P output from the radiation sensor 25 becomes greater than in a case where X-rays emitted from the X-ray generator enter the radiation sensor 25 once, as described above.

In view of this, in an example structure 2, the determining unit 22 can be designed to determine that radiation having entered the radiation sensor 25 is natural radiation when the total value σWp of the pulse widths Wp of a predetermined number of pulse signals P that are output from the radiation sensor 25 is equal to or greater than a threshold value σth, for example. In the description below, the predetermined time ΔT is set in the example structure 2 as in the example structure 1. However, the predetermined time ΔT is not necessarily set in the example structure 2.

Specifically, in a case where the above described predetermined number is set at 2 in the example shown in FIG. 6A, the determining unit 22 determines that the radiation having entered the radiation sensor 25 is not natural radiation, because the pulse signal P is generated only once in the predetermined time ΔT. In a case where the pulse signals P are successively output in the predetermined time ΔT as shown in FIG. 6B, the determining unit 22 determines that the radiation having entered the radiation sensor 25 is not natural radiation if the total value σWp of the pulse widths Wp (Wp1 and Wp2 in the case shown in FIG. 6B) of the two pulse signals P including the first pulse signal P is smaller than the threshold value σth.

On the other hand, in a case where the total value σWp of the pulse widths Wp (Wp3 and Wp4 in the case shown in FIG. 7A, Wp7 and Wp8 in the case shown in FIG. 7B) of the two pulse signals P (the two pulse signals P on the left side among the waveforms of the four pulse signals P output in the predetermined time ΔT in the case shown in FIG. 7A) including the first pulse signal P output in the predetermined time ΔT is equal to or greater than the threshold value σth as in the cases shown in FIGS. 7A and 7B, for example, the determining unit 22 determines that the radiation having entered the radiation sensor 25 is natural radiation.

In other words, in this example structure 2, the threshold value σth at the determining unit 22 is set so that natural radiation is not detected (or non-natural radiation is detected) when the threshold value σth is a value shown in FIG. 6B, and natural radiation is detected when the threshold value σth is a value shown in FIG. 7A or 7B.

### Example Structure 3

When natural radiation enters the radiation sensor 25 once, the pulse width of the pulse signal P output from the radiation sensor 25 is normally greater than in a case where X-rays emitted from the X-ray generator enter the radiation sensor 25 once, as described above. With this phenomenon being taken advantage of in an example structure 3, attention is paid to the pulse width Wp of the second pulse signal P that is output after the first pulse signal P is output from the radiation sensor 25, for example.

The determining unit 22 can be designed to determine that radiation having entered the radiation sensor 25 is natural radiation when the pulse width Wp of the second pulse signal P (the pulse width of the pulse signal P denoted by C after the pulse signal P denoted by B in FIG. 3, the pulse width WP2, Wp4, or Wp8 in FIG. 6B or FIG. 7A or 7B) is equal to or greater than a threshold value Wpth. That is, in the case of the pulse signal P denoted by C in FIG. 3 or the pulse signal P shown in FIG. 6B, the determining unit 22 can determine that the radiation having entered the radiation sensor 25 is not natural radiation, because the pulse width Wp (the pulse width Wp2 in the case shown in FIG. 6B) is smaller than the threshold value Wpth. In the case of the pulse signal shown in FIG. 7A or 7B, the determining unit 22 can determine that the radiation having entered the radiation sensor 25 is natural radiation, because the pulse width Wp (or the pulse width Wp4 or Wpb) is equal to or greater than the threshold value Wpth.

In other words, in this example structure 3, the above described threshold value Wpth at the determining unit 22 is set so that natural radiation is not detected (or non-natural radiation is detected) when the threshold value Wpth is the value indicated by C in FIG. 3 or is the value shown in FIG. 6B, and natural radiation is detected when the threshold value Wpth is a value shown in FIG. 7A or 7B.

When natural radiation enters the radiation sensor. 25 once, the number of times the pulse signal P is output from the radiation sensor 25 is normally larger, and the pulse width of the pulse signal P output from the radiation sensor 1 is normally greater than in a case where X-rays emitted from the X-ray generator enter the radiation sensor 25 once, as described above. With this phenomenon being taken advantage of in the above described example structures 1 to 3, a check can be made to determine whether radiation having entered the radiation sensor 25 is natural radiation. At this point, the above described threshold value Σth, σth, or WPth is appropriately set, so that the radiation having entered the radiation sensor 25 can be accurately determined to be natural radiation or X-rays emitted from the X-ray generator.

Two or all of the above described example structures 1 to 3 can be combined so that radiation having entered the radiation sensor 25 is determined to be natural radiation when the determining unit 22 determines that the radiation having entered that radiation sensor 25 is natural radiation in one, two, or all of the example structures 1 to 3. The above described example structures 1 to 3 can also be combined with another determination method so as to perform the determination process.

Where the total value ΣWp or σWp of the pulse widths Wp of pulse signals P is calculated as in the above described example structure 1 or 2, the difference between the total value ΣWp or σWp calculated when natural radiation enters the radiation sensor 25 and the total value ΣWp or σWp calculated when X-rays emitted from the X-ray generator enter the radiation sensor 25 is larger than in a case where the pulse width Wp of a single pulse signal P is used as in the example structure 3. Accordingly, the example structures 1 and 2 have the advantage of being able to easily distinguishing X-ray emission and natural radiation from each other based on the threshold value Σth or σth. On the other hand, where the pulse width Wp of a single pulse signal P is compared with the threshold value Wpth as in the example structure 3, the process of adding up pulse widths is unnecessary. Accordingly, the example structure 3 has the advantage of being able to perform processing quickly.

### Process at the Emission Start Detecting Unit According to This Embodiment

Meanwhile, the emission start detecting unit 22 (the control unit 22 in this embodiment) is designed to determine whether X-ray emission from the X-ray generator has been started based on a determination result indicating that the determining unit 22 has determined that the radiation is not natural radiation as described above.

In the simplest structure in this case, the emission start detecting unit 22 can be designed to instantly determine that X-ray emission from the X-ray generator has been started when the determining unit 22 has determined that the radiation having entered the radiation sensor 22 is not natural radiation but X-rays emitted from the X-ray generator in the above described manner.

As shown in FIGS. 7A and 7B, in a case where natural radiation having a great energy enters the radiation sensor 25, the temporal transition of the analog voltage value Va of the radiation sensor 25 differs from that in a case where X-rays emitted from the X-ray generator enter the radiation sensor 25 (see FIGS. 6A and 6B). Therefore, in a case where the determining unit 22 has one of the above described example structures 1 to 3, the threshold value Σth, σth, or WPth is set at an appropriate value, so that a check can be accurately made to determine whether radiation having entered the radiation sensor 25 is natural radiation based on the threshold value Σth, σth, or Wpth.

However, in a case where the energy of natural radiation is small, for example, the temporal transition of the analog voltage value Va of the radiation sensor 25 is not much different from that in a case where X-rays emitted from the X-ray generator enter the radiation sensor 25, though the radiation having entered the radiation sensor 25 is natural radiation. As a result, the determining unit 22 might wrongly determine that the radiation having entered the radiation sensor 25 is X-rays emitted from the X-ray generator. In a case where the energy of X-rays emitted from the X-ray generator is extremely strong, the above described threshold value Σth, σth, or Wpth is set at a greater value than in a case where emitted X-rays are weak. In this case, natural radiation having entered the radiation sensor 25 is not accurately distinguished from X-rays emitted from the X-ray generator based on the threshold value Σth, σth, or Wpth, and radiation having entered the radiation sensor 25 might be wrongly determined to be X-rays emitted from the X-ray generator, though the radiation having entered the radiation sensor 25 is natural radiation.

So as to prevent false detection of an X-ray emission start from the X-ray generator based on wrong determination, attention can be paid to the other one of the above described characteristic differences between natural radiation and X-rays emitted from the X-ray generator. Specifically, in a case where X-rays are emitted from the X-ray generator, the photons forming the X-rays constantly enter the radiation sensor 25, and the pulse signal P continues to be intermittently output from the radiation sensor 25, as described above. In a case where natural radiation enters the radiation sensor 25, on the other hand, more than one pulse signal P might be output in response to one-time entrance of natural radiation into the radiation sensor 25, but no more pulse signals P are output thereafter, as shown in FIGS. 7A and 7B.

With attention being paid to the above described characteristic difference, the emission start detecting unit 22 in this embodiment excludes determination results indicating that the determining unit 22 has determined that radiation having entered the radiation sensor 25 is natural radiation, and determines that X-ray emission from the X-ray generator has been started only when a predetermined number of determination results indicating that the determining unit 22 has determined that radiation having entered the radiation sensor 25 is not natural radiation (or is X-rays emitted from the X-ray generator) are generated within a certain time δT. The certain time δT in this case is sufficiently larger than the above described predetermined time ΔT (such as 100 μs or 200 μs) at the determining unit 22, and is on the order of milliseconds, for example.

In such a structure, each pulse signal P in the portion denoted by A in the example shown in FIG. 3 is excluded, because the determining unit 22 determines that the radiation having entered the radiation sensor 25 is natural radiation. On the other hand, the pulse signals P denoted by B and C in FIG. 3 indicate that the pulse signal P denoted by C is output within the above described certain time δT (not shown in FIG. 3) but after the above described predetermined time ΔT has passed since the output of the pulse signal P denoted by B, and accordingly, the determining unit 22 determines that the radiation having entered the radiation sensor 25 is not natural radiation in either case. In view of this, as for each of the pulse signals P denoted by B and C, the emission start detecting unit 22 determines that the radiation having entered the radiation sensor 25 is not natural radiation. Therefore, a determination result indicating that the determining unit 22 has determined that radiation having entered the radiation sensor 25 is not natural radiation (or is X-rays emitted from the X-ray generator) is generated twice within the certain time δT in this case.

Only after such a determination result is generated from the determining unit 22 a predetermined number of times such as three or five within the above described certain time δT, does the emission start detecting unit 22 determine that X-ray emission from the X-ray generator has started.

With such a structure, even if the determining unit 22 has wrongly determined that natural radiation having entered the radiation sensor 25 is X-rays emitted from the X-ray generator in a case where the threshold value Σth, σth, or Wpth is set at a great value because the energy of the natural radiation having entered the radiation sensor 25 is small or the X-rays emitted from the X-ray generator are strong, natural radiation does not actually enter the radiation sensor 25 again a predetermined number of times within the certain time δT thereafter, as long as the radiation having entered the radiation sensor 25 is natural radiation. Accordingly, with the above described structure, the emission start detecting unit 22 can be appropriately prevented from wrongly determining that X-ray emission from the X-ray generator has been started based on entrance of natural radiation into the radiation sensor 25.

In a case where X-rays are emitted from the X-ray generator, even if the determining unit 22 determines that the radiation having first entered the radiation sensor 25 is natural radiation, and excludes the determination result though the radiation having first entered the radiation sensor 25 is X-rays emitted from the X-ray generator, the photons of X-rays continue to enter the radiation sensor 25 thereafter, as described above. Accordingly, a predetermined number of determination results indicating that the determining unit 22 has determined that radiation having entered the radiation sensor 25 is not natural radiation (or is X-rays emitted from the X-ray generator) are certainly generated within the certain time δT. Thus, with the above described structure, the emission start detecting unit 22 can accurately determine that X-ray emission from the X-ray generator has been started where X-rays have actually been emitted from the X-ray generator.

As described above, with the above described structure, false detection of a start of X-ray emission from the X-ray generator can be appropriately prevented in a case where natural radiation has entered the radiation sensor 25, and a start of X-ray emission from the X-ray generator can be accurately detected in a case where X-rays have been emitted from the X-ray generator.

### Processes to be Performed After an X-ray Emission Start is Detected

After determining that X-ray emission from the X-ray generator has been started in the above described manner, the emission start detecting unit 22 of the X-ray imaging apparatus 1 controls the scanning drive unit 15 (see FIG. 5) so that an off-state voltage is applied from the gate driver 15b to each of the lines L1 to Lx of the scanning lines 5 to put each TFT 8 into an OFF state. The X-ray imaging apparatus 1 then enters a charge accumulating state in which the charges generated in the detecting elements 7 by X-ray emission are accumulated in the detecting elements 7.

After the X-ray emission has ended, the control unit 22 sequentially applies an on-state voltage from the gate driver 15b of the scanning drive unit 15 to each of the lines L1 to Lx of the scanning lines 5, and the image data D is read out from the respective detecting elements 7 in the above described manner. Also, known processes, such as the process of reading out offset data 0 before or after imaging, and the process of transmitting the image data D and the offset data 0 from the X-ray imaging apparatus 1 to an image processing apparatus, are performed.

### Advantageous Effects

As described above, in the X-ray imaging apparatus 1 according to this embodiment, the determining unit 22 is designed to determine whether radiation having entered the radiation sensor 25 is natural radiation based on the pulse width Wp of a pulse signal P output from the radiation sensor 25 (or on the length of the period during which the analog voltage value Va converted from the value of the current flowing in the radiation sensor 25 is outside the predetermined range), and the emission start detecting unit 22 is designed to determine whether X-ray emission from the X-ray generator has been started based on a determination result indicating that the determining unit 22 has determined that the radiation having entered the radiation sensor 25 is not natural radiation (or on a determination result indicating that the radiation having entered the radiation sensor 25 is X-rays emitted from the X-ray generator).

Accordingly, a start of X-ray emission from the X-ray generator can be accurately detected when the X-ray emission has actually been started, and false detection of an X-ray emission start based on entrance of natural radiation into the radiation sensor 25 can be appropriately prevented.

The determination process by the determining unit 22 and the detection process by the emission start detecting unit 22 are performed on the order of milliseconds at a maximum, as described above. Accordingly, natural radiation and an X-ray emitted from the X-ray generator can be distinguished from each other in real time. As soon as X-ray emission from the X-ray generator is started, each TFT 8 is put into an OFF state, and the X-ray imaging apparatus 1 enters a charge accumulating state in which charges generated in the respective detecting elements 7 by the X-ray emission can be appropriately accumulated in the respective detecting elements 7, and a radiation image can be accurately captured and generated.

Also, in the X-ray imaging apparatus 1 according to this embodiment, even when natural radiation such as a cosmic ray has entered the radiation sensor 25, false detection of a start of X-ray emission from the X-ray generator can be appropriately prevented. Accordingly, the X-ray imaging apparatus 1 can perform imaging without being affected by any restrictions, since there is no need to position the X-ray imaging apparatus 1 so that the normal line of the detection surface of the radiation sensor 25 attached to the X-ray imaging apparatus 25 extends substantially in the horizontal direction prior to imaging as disclosed in JP 4881796 B1, which has been described above.

Accordingly, an X-ray imaging apparatus of a portable type (a cassette type) can be inserted between the body of a patient and a bed before imaging, for example. In this manner, imaging can be performed by taking advantage of the portable X-ray imaging apparatus. Also, an X-ray imaging apparatus of a special-purpose type for supine radiography can perform accurate imaging without being affected by natural radiation such as cosmic rays.

In the above described embodiment, the process of detecting a start of X-ray emission from the X-ray generator (or the above described determination process and detection process) is performed only with the use of the radiation sensor 25. However, it is also possible to detect an X-ray emission start by using the method according to the present invention in conjunction with a method of detecting an X-ray emission start based on the current flowing in the bias lines 9 (see FIG. 5) as disclosed in JP 2009-219538 A and others, a method of detecting an X-ray emission start based on leak data dleak or the like generated by reading out charges leaking from the detecting elements 7 via the TFTs 8 in an OFF state as disclosed in WO 2011/135917 A and others, a method of detecting an X-ray emission start based on image data that is read out through an image data readout process prior to imaging as disclosed in WO 2011/152093 A and others, or the like.

In a case where more than one radiation sensor 25 is provided in the X-ray imaging apparatus 1, when X-rays are emitted from the X-ray generator, the X-rays can enter the radiation sensors 25 located in the X-ray field in the X-ray imaging apparatus 1. Accordingly, more than one radiation sensor 25 located in the X-ray field continues to intermittently output the pulse signal P as long as the X-ray emission continues, as described above. In a case where natural radiation enters the radiation sensor 25, on the other hand, only one radiation sensor 25 among the radiation sensors 25 provided in the X-ray imaging apparatus 1 outputs the pulse signal P, and the output of the pulse signal P is stopped after the pulse signal P based on one-time entrance of natural radiation is output from the one radiation sensor 25 several times (see FIGS. 7A and 7B, for example)

Therefore, in a case where radiation sensors 25 are provided in the X-ray imaging apparatus 1, not only the process of detecting an X-ray emission start described in the above embodiment (the above described determination process and detection process) can be performed, but also a process of detecting an X-ray emission start can be designed by taking into account the difference between the phenomenon that occurs when natural radiation enters the radiation sensors 25 and the phenomenon that occurs when X-rays emitted from the X-ray generator enter the radiation sensors 25, and combining them.

The present invention is not limited to the above described embodiment, and changes may be of course made to it without departing from the scope of the invention.

Although the present invention has been described and illustrated in detail, it is clearly understood that the same is by way of illustrated and example only and is not to be taken by way of limitation, the scope of the present invention being interpreted by terms of the appended claims.

What is claimed is:

1. An X-ray imaging apparatus comprising:
a plurality of detecting elements arranged two-dimensionally;
a radiation sensor configured to change a voltage value to be output when radiation is emitted;
a determining unit configured to determine whether radiation that has entered the radiation sensor is natural radiation based on a length of a period during which the voltage value output from the radiation sensor is outside a predetermined range set for the voltage value; and
an emission start detecting unit configured to determine whether X-ray emission from an X-ray generator has been started based on a determination result indicating that the determining unit has determined that the radiation having entered the radiation sensor is not natural radiation.

2. The X-ray imaging apparatus according to claim 1, wherein
the radiation sensor outputs a pulse signal when the voltage value changes to a voltage value outside the predetermined range, and
the determining unit determines whether the radiation having entered the radiation sensor is natural radiation based on a pulse width of the pulse signal output from the radiation sensor.

3. The X-ray imaging apparatus according to claim 2, wherein, when a total value of lengths of the periods that appear in a predetermined time since the voltage value output from the radiation sensor changes to a voltage value outside the predetermined range is equal to or greater than a threshold value, or when a total value of pulse widths of pulse signals output in a predetermined time since the pulse signal is first output from the radiation sensor is equal to or greater than a threshold value, the determining unit determines that the radiation having entered the radiation sensor is natural radiation, the pulse signals including the first output pulse signal.

4. The X-ray imaging apparatus according to claim 2, wherein, when a total value of lengths of a predetermined number of the periods that appear since the voltage value output from the radiation sensor changes to a voltage value outside the predetermined range is equal to or greater than a threshold value, or when a total value of pulse widths of a predetermined number of pulse signals output from the radiation sensor is equal to or greater than a threshold value, the determining unit determines that the radiation having entered the radiation sensor is natural radiation, the pulse signals including the pulse signal.

5. The X-ray imaging apparatus according to claim 2, wherein, when a length of a second period that appears after the first period appears since the voltage value output from the radiation sensor changes to a voltage value outside the predetermined range is equal to or greater than a threshold value, or when a pulse width of the pulse signal output for the second time after the pulse signal is output from the radiation sensor for the first time is equal to or greater than a threshold value, the determining unit determines that the radiation having entered the radiation sensor is natural radiation.

6. The X-ray imaging apparatus according to claim 1, wherein, when the determining unit determines that radiation having entered the radiation sensor is not natural radiation a predetermined number of times in a certain time, the emission start detecting unit determines that X-ray emission from the X-ray generator has been started.

7. The X-ray imaging apparatus according to claim 1, further comprising
a plurality of switching elements configured to accumulate charges in the detecting elements when an off-state voltage is applied from a scanning drive unit via a scanning line, and release charges accumulated in the detecting elements to a signal line when an on-state voltage is applied,
wherein, when determining that X-ray emission from the X-ray generator has been started, the emission start detecting unit controls the scanning drive unit to put each of the switching elements into an off state, and put the X-ray imaging apparatus into a charge accumulating state in which charges generated in the detecting elements by X-ray emission are accumulated in the detecting elements.
